(19) United States
(12) Patent Application Publication
(10) Pub. No.: US 2003/0093937 A1
(43) Pub. Date: May 22, 2003

(54) Tool for passing line through eye of fish hook

(76) Inventor: Mitsunori Murata, Shiga (JP)

Correspondence Address: DARBY & DARBY P.C., P. O. BOX 5257, NEW YORK, NY, 10150-5257, US

(21) Appl. No.: 09/992,182

(22) Filed: Nov. 19, 2001

(51) Int. Cl. A01M 31/06

(52) U.S. Cl. 43/3

(57) ABSTRACT

A tool for passing a line through the eye of a fishhook comprising a fine wire fixed at the rear end thereof to a wire holder and having at the rear and front portions a linear portion and a diamond-shaped portion which can be linearly pressed respectively. A wire-covering tube, which is shorter than the linear portion and has an inner diameter capable of linearly pressing the diamond-shaped portion, is longitudinally movably fitted onto the wire.

### BACKGROUND OF THE INVENTION

1. Field of the Invention

The present invention relates to a tool for passing a line through the eye of a fishhook such as a fly.

2Description of the Related Art

A conventional tool for passing a line through the eye of a fishhook comprises a fine wire adapted to insert the eye and fixed at the rear end to a wire holder and having at the rear and front portions a linear portion and a diamond-shaped portion which can be linearly pressed respectively.

In use, the diamond-shaped portion of the wire is linearly pressed by a finger and is inserted at the front end into the eye of the fishhook. The inserted front end of the wire is forward pulled out from the eye until the whole diamond-shaped portion is passed therethrough so as to be restored to its normal diamond shape.

After a line is inserted at the front end thereof into the diamond-shaped portion, the wire is pulled out from the eye through a relative movement between the wire and the fishhook. At this time, the line is caught in the linearly pressed diamond-shaped portion and is guided into and passed through the eye.

The conventional tool is not problematical in function, but the wire is extremely small in diameter corresponding to the eye and exceedingly easy to sway, so that it is hard to insert or pass the diamond-shaped portion into or through the eye.

### SUMMARY OF THE INVENTION

Accordingly, an object of the present invention is to improve the conventional tool so that the wire is hard to sway and therefore the diamond-shaped portion is easy to insert into or pass through the eye of the fishhook.

The present invention provides a tool for passing a line through the eye of a fishhook which comprises a fine wire fixed at the rear end to a wire holder and having at the rear and front portions a linear portion and a diamond-shaped portion which can be linearly pressed respectively, the improvement comprising a wire-covering tube longitudinally movably fitted onto the wire, the tube being shorter than the linear portion and having an inner diameter enabling the diamond-shaped portion to press linearly.

When the tool according to the invention is used, firstly, the wire-covering tube is relatively forward moved with respect to the wire so that substantially the front half end of the diamond-shaped portion projects in linearly pressed shape from the front end of the tube.

Secondly, the front end of the linearly pressed diamond-shaped portion is inserted into the eye of the fishhook, and then is pulled forward while moving the tube toward the linear portion until the whole diamond-shaped portion is passed through the eye and return to its normal diamond shape. Thus, the rear portion of the diamond-shaped portion and the linear portion adjacent thereto is covered by the tube so as to be substantially restricted from the swaying motion, thereby facilitating the insertion of the diamond-shaped portion into the eye.

Thirdly, After one end of the line is inserted into the diamond-shaped portion, the diamond-shaped portion is pulled out from the eye through the relative movement between the wire and the fishhook. As a result, the line is caught into the linearly pressed diamond-shaped portion and is inserted into the eye. At this time, the tube also covers the linear portion so as to restrain its swaying motion, thereby enabling the line to be easily passed through the eye.

The wire-covering tube is preferably lightly made to minimize bending or breaking of the fine wire due to the load thereof.

In further accordance with the present invention, in order that the load of the wire-covering tube does not substantially act on the fine wire, there is provided a modified form of the tool wherein the wire holder is longitudinally movably mounted on the rear portion of an elongated base member and the wire-covering tube is fixedly mounted on the front portion of the elongated base member.

In this modified form, the wire holder may be a slider slidable along a longitudinally extending slide guide provided at the elongated base member.

Further, the tube may be integrally molded with the base member.

Other objects, features and advantages of the invention will become more apparent from the following description taken in connection with the accompanying drawings.

### BRIEF DESCRIPTION OF THE DRAWINGS

FIG. 1 is a perspective view of an embodiment of a tool for passing a line according to the present invention additionally showing a fishhook through the eye of which a diamond-shaped portion of a fine wire is passed and a line inserted into the diamond-shaped portion;

FIG. 2 is a perspective view of the same additionally showing the fishhook into the eye of which the front end of the diamond-shaped portion of the wire is inserted; and

FIG. 3 is a perspective view, similar to FIG. 1, of a modified embodiment of the tool according to the invention.

### DESCRIPTION OF THE EMBODIMENTS

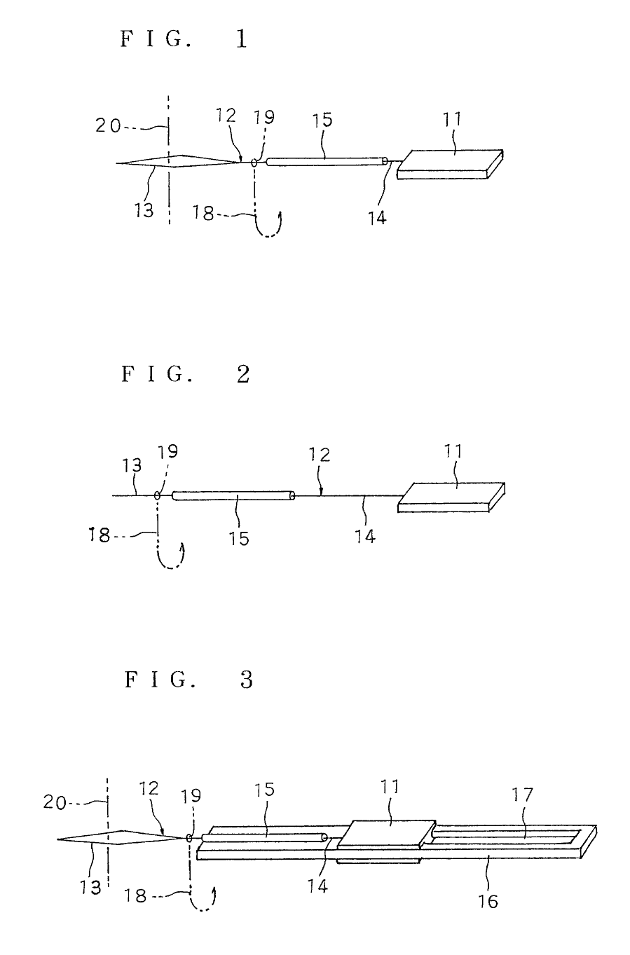

Referring first to FIG. 1 and 2, there is shown an embodiment of a tool according to the invention which comprises a fine wire 12 made of steel wire such as a piano wire and fixed at the rear end thereof to a wire holder 11 made of plastic. The wire 12 has a diameter adapted to insert into the eye 19 of a fishhook 18 and at front and rear portions a diamond-shaped portion 13 capable of pressing linearly and a linear portion 14 longer than the portion 13 respectively.

A wire-covering tube 15 made of plastic has the length approximately equal to the diamond-shaped portion 13 and is longitudinally, or forward and backward, movably fitted onto the wire 12.

In use, at the first place, the tube 15 is relatively forward moved with respect to the wire 12 until nearly the front half of the linearly pressed diamond-shaped portion 13 projects from the tube 15 as shown in FIG. 2. Next, the front end of the diamond-shaped portion 13 is inserted into the eye 19 of the fishhook 18 (see FIG. 2), and then is pulled forward while relatively rearward moving the tube 15 with respect to the wire 12 until the whole diamond-shaped portion 13 is passed through the eye 19 so as to be restored to its normal diamond shape (see FIG. 1). At this time, the tube 15 is positioned on the linear portion 14.

Thereafter a line 20 is inserted at the end thereof into the diamond-shaped portion 13, and then the portion 13 is pulled out from the eye 19 through the relatively movement between the fishhook 18 and the wire 12. This operation results in that the line 20 is caught into the linearly pressed diamond-shaped portion 13 and is passed through the eye 19.

Referring to FIG. 3 illustrating a modified embodiment of a tool according to the invention, the wire holder 11 and the wire-covering tube 15 are longitudinally movably and immovably mounted on the rear and front portions of a elongated base member 16 made of plastic respectively. Namely, the wire holder 11 is slidably engaged with a longitudinally extending guide hole 17 provided at the rear half portion of the base member 16, and the tube 15 made of plastic is integrally molded with the base member 16 on the extension of the guide hole 17 thereof. The fine wire 12 extending from the wire holder 11 is passing through the immovable tube 15.

In case of using this modified embodiment, the wire holder 11 is slid along the guide hole 17 at the elongated base member 16 until nearly the front half of the linearly pressed diamond-shaped portion 13 projects from the front end of the tube 15. Then, the diamond-shaped portion 13 is inserted at the front end thereof into the eye 19 of the fishhook 18, and is passed therethrough by forward pulling of the front end of the portion 13 or forward sliding of the wire holder 11 along the guide hole 17.

After one end of the line 20 is inserted into the diamond-shaped portion 13, the portion 13 is pulled out from the eye 19 through the relative movement between the fishhook 18 and the wire holder 11 or the base member 17. As a result, the line 20 is caught in the linearly pressed portion 13 and is passed through the eye 19.

Although the tool of the present invention has been described in its preferred embodiments thereof, it is to be understood that the invention is not limited thereto and that various changes and modifications may be made without departing from the spirit and scope of the invention as hereinafter claimed.

What is claimed is:

1. A tool for passing a line through the eye of a fishhook comprising a fine wire fixed at the rear end thereof and having at the rear and front portions a linear portion and a diamond-shaped portion which can be linearly pressed respectively, the improvement comprising a wire-covering tube being longitudinally movably fitted onto said wire, said wire-covering tube being shorter than said linear portion and having an inner diameter enabling said diamond-shaped portion to press linearly.

2. A tool as claimed in claim 1, wherein said wire-covering tube is lightly made.

3. A tool as claimed in claim 1, wherein said wire holder is longitudinally movably mounted on the rear portion of an elongated base member and said wire-covering tube is fixedly mounted on the front portion of said elongated base member.

4. A tool as claimed in claim 3, wherein said wire holder is a slider slidable along a longitudinally extending slide guide provided at said elongated base member.

5. A tool as claimed in claim 3 or 4, said wire-covering tube is integrally molded with said elongated base member.
